(19) United States
(12) Patent Application Publication
(10) Pub. No.: US 2026/0065057 A1
(43) Pub. Date: Mar. 5, 2026

(54) LATENT FEATURE ACTIVITY CONSTRAINTS FOR ENSURING EXPLAINABILITY IN INTERPRETABLE NEURAL NETWORK MODELS

(71) Applicant: FAIR ISAAC CORPORATION, Minneapolis, MN (US)

(72) Inventors: Scott Michael Zoldi, San Diego, CA (US); Krzysztof Nalborski, San Diego, CA (US)

(21) Appl. No.: 18/917,370

(22) Filed: Oct. 16, 2024

Related U.S. Application Data
(60) Provisional application No. 63/688,584, filed on Aug. 29, 2024.

(51) Int. Cl. G06N 3/082

(52) U.S. Cl. CPC G06N 3/082

(57) ABSTRACT

A method for generating a classifier, comprising: initializing a neural network with a fully connected architecture; applying a regularization constraint to the set of weights between neurons in the input layer and the plurality of latent features in the hidden layer; iteratively reducing a number of incoming connections to each latent feature in the hidden layer to a predetermined number based on the regularized first set of weights; weighting loss function's value based on categories of activation tuples, wherein contributions of data entries with activation tuples of size greater than a predetermined threshold to the loss function's value are limited and wherein contributions of data entries with activation tuples of size “0” to the loss function's value are minimized, to a predefined percentage; and selectively updating sets of weights associated with top-ranked latent features as evaluated by the magnitude of their contributions at the output layer in a training process.

### CROSS-REFERENCE

This application claims priority to U.S. Patent Application No. 63/688,584, filed Aug. 29, 2024, the contents of which are fully incorporated by reference.

### TECHNICAL FIELD

The subject matter described herein relates to machine learning (ML) technology, specifically systems and methods for applying latent feature activity constraints to promote explainability in neural network ML models.

### BACKGROUND

In recent years, Machine Learning (ML) models have gained widespread adoption across various industries for predictive purposes. For instance, in the retail sector, predictive models are utilized to forecast customer demand, optimize inventory levels, and personalize marketing campaigns, ultimately resulting in increased sales and improved customer satisfaction. In healthcare, predictive models play a crucial role in patient diagnosis, treatment recommendations, and disease outbreak predictions, contributing to enhanced patient care and proactive healthcare management. Furthermore, within the financial industry, ML models are employed for credit risk assessment, fraud detection, and market trend predictions, thereby enhancing decision-making processes, and mitigating potential risks. These examples illustrate the substantial impact of predictive ML models, transforming industries and driving data-driven decision-making across diverse sectors.

There are cases where providing explanations for machine learning classifier outputs becomes essential or, in some instances, required, due to, for example, regulatory requirements. Moreover, these explanations can offer valuable insights for further model development in various scenarios. However, despite their utility, traditional neural network models often suffer from a lack of interpretability, which makes it difficult for users to understand how specific decisions are made. This “black box” nature is a significant hurdle in domains where transparency is critical, such as healthcare and finance. Additionally, these models can overfit to training data, failing to generalize well to new, unseen data, leading to unreliable predictions. This overfitting is often exacerbated by complex hidden layer co-adaptations within the network, where multiple features interact in non-transparent ways. Another challenge with conventional neural networks relates to their dense connections where densely connected latent features are inherently uninterpretable and unexplainable because of the combinatorial explosion of possible reasons for a latent feature value. This not only makes the models computationally expensive to train and deploy but also adds to the difficulty in interpreting the results. These issues collectively necessitate the development of advanced methods to enhance the transparency, robustness, and efficiency of neural network models, ensuring they can be reliably used and sufficiently explained in critical applications.

### SUMMARY

Methods, systems, and computer program products are provided for generating a classifier using a neural network architecture. In one aspect, a computer-implemented method includes initializing a neural network classifier with a fully connected architecture, comprising an input layer, a hidden layer, and an output layer. The hidden layer includes a plurality of latent features. A regularization constraint is applied to a first set of weights between the neurons in the input layer and the latent features in the hidden layer. The method further includes iteratively reducing the number of incoming connections to each latent feature in the hidden layer to a predetermined number per latent feature, based on the regularized first set of weights. Upon determining that the proportion of data entries with activation tuples of size “0” is below a specified threshold, a loss function weighting is employed. The contributions of data entries with activation tuples of size greater than a predetermined threshold are minimized, while contributions of data entries with activation tuples of size “0” are reduced to a predefined percentage. The method also involves selectively updating a second set of weights of top-ranked latent features, as evaluated by the magnitude of their contributions at the output layer, during the training process.

In some variations, the predetermined number of incoming connections to each latent feature is set to one or two.

In some variations, the regularization constraint applied to the first set of weights is an Li-based regularization constraint.

In some variations, the specified threshold for the proportion of data entries with activation tuples of size “0” is less than or equal to a predetermined percentage.

In some variations, the method further comprises adjusting the learning rate during different stages of the training process.

In some variations, iteratively reducing the number of incoming connections to each latent feature in the hidden layer includes evaluating the importance of each connection based on the magnitude of the regularized first set of weights.

In some variations, the method further includes retaining only the top-ranked connections for each latent feature while constraining the remaining connections to zero.

In another aspect, a computer program product is provided. The computer program product includes a non-transient machine-readable medium storing instructions that, when executed by at least one programmable processor, cause the at least one programmable processor to perform operations comprising initializing a neural network classifier with a fully connected architecture comprising an input layer, a hidden layer, and an output layer, wherein the hidden layer comprises a plurality of latent features; applying a regularization constraint to a first set of weights between neurons in the input layer and the plurality of latent features in the hidden layer; iteratively reducing a number of incoming connections to each latent feature in the hidden layer to a predetermined number per latent feature based on the regularized first set of weights; upon determining that a proportion of data entries with activation tuples of size “0” is below a specified threshold, employing a loss function weighting based on activation tuples, wherein contributions of data entries with activation tuples of size greater than a predetermined threshold are minimized and contributions of data entries with activation tuples of size “0” are reduced to a predefined percentage; and selectively updating a second set of weights of top-ranked latent features as evaluated by a magnitude of their contributions at the output layer in a training process.

In some variations, the predetermined number of incoming connections to each latent feature is set to one or two.

In some variations, the regularization constraint applied to the first set of weights is an Li-based regularization constraint.

In some variations, the specified threshold for the proportion of data entries with activation tuples of size “0” is less than or equal to a predetermined percentage.

In some variations, the operations further include adjusting the learning rate during different stages of the training process.

In some variations, iteratively reducing the number of incoming connections to each latent feature in the hidden layer includes evaluating the importance of each connection based on the magnitude of the regularized first set of weights.

In some variations, the operations further include retaining only top-ranked connections for each latent feature while constraining the remaining connections to zero.

In another aspect, a system is provided. The system includes a programmable processor and a non-transient machine-readable medium storing instructions that, when executed by the processor, cause the at least one programmable processor to perform operations comprising initializing a neural network classifier with a fully connected architecture comprising an input layer, a hidden layer, and an output layer, wherein the hidden layer comprises a plurality of latent features; applying a regularization constraint to a first set of weights between neurons in the input layer and the plurality of latent features in the hidden layer; iteratively reducing a number of incoming connections to each latent feature in the hidden layer to a predetermined number per latent feature based on the regularized first set of weights; upon determining that a proportion of data entries with activation tuples of size “0” is below a specified threshold, employing a loss function weighting based on activation tuples, wherein contributions of data entries with activation tuples of size greater than a predetermined threshold are minimized and contributions of data entries with activation tuples of size “0” are reduced to a predefined percentage; and selectively updating a second set of weights of top-ranked latent features as evaluated by a magnitude of their contributions at the output layer in a training process.

In some variations, the operations further include setting a predetermined number of incoming connections to each latent feature to one or two.

In some variations, the regularization constraint applied to the first set of weights is an Li-based regularization constraint.

In some variations, the specified threshold for the proportion of data entries with activation tuples of size “0” is less than or equal to a predetermined percentage.

In some variations, the operations further include adjusting the learning rate during different stages of the training process.

In some variations, iteratively reducing the number of incoming connections to each latent feature in the hidden layer includes evaluating the importance of each connection based on the magnitude of the regularized first set of weights.

In some variations, the operations further include retaining only top-ranked connections for each latent feature while constraining the remaining connections to zero.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an example of a fully-connected neural network model with a single hidden layer, in accordance with one or more embodiments of the current subject matter.

FIG. 2 is a diagram illustrating an example of a single latent feature LF1 with two incoming connections, in accordance with one or more embodiments of the current subject matter.

FIG. 3 is a diagram illustrating an example of a hyperbolic tangent (tanh) activation function, in accordance with one or more embodiments of the current subject matter.

FIG. 4 is a diagram illustrating an example of latent features' activation values and their corresponding pre-activation terms at the output layer, in accordance with one or more embodiments of the current subject matter.

FIG. 5 is a diagram illustrating an example of a training mini-batch containing 15 data entries (e.g., transactions) and their activation tuples of different categories, in accordance with one or more embodiments of the current subject matter.

FIG. 6 is a diagram illustrating an example of an interpretable neural network where all latent features (LF1, LF2, LF3, LF4, LF5) have 2-input connections, in accordance with one or more embodiments of the current subject matter.

FIG. 7 is an example of is an example of a training framework A, in accordance with one or more embodiments of the current subject matter.

FIG. 8 is an example of is an example of a training framework B with additional explainability constraints in comparison with the framework A, in accordance with one or more embodiments of the current subject matter.

FIG. 9 is a diagram illustrating a flow chart of a process 900 for generating a classifier, in accordance with one or more embodiments of the current subject matter

FIG. 10 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

As discussed herein elsewhere, neural network models have been commonly used in numerous applications across different industries to solve many challenging problems. Whether it has been for credit and debit card fraud detection or loan default prediction in banking, medical image classification in healthcare and speech recognition in natural language processing, neural networks have proven to be a powerful form of machine learning enabling decision makers to gain competitive advantage and consequently grow their market share. As neural networks and other machine learning models have become mainstream and their adoption has grown, it attracted interest from regulators and governing bodies to take a closer look at how these algorithms are used to make different decisions. In some situations, automated decisions made with the help of machine learning models such as neural networks affect lives of many people, and there exist needs to ensure the models be developed and deployed in a way that emphasizes fairness, interpretability, and explainability

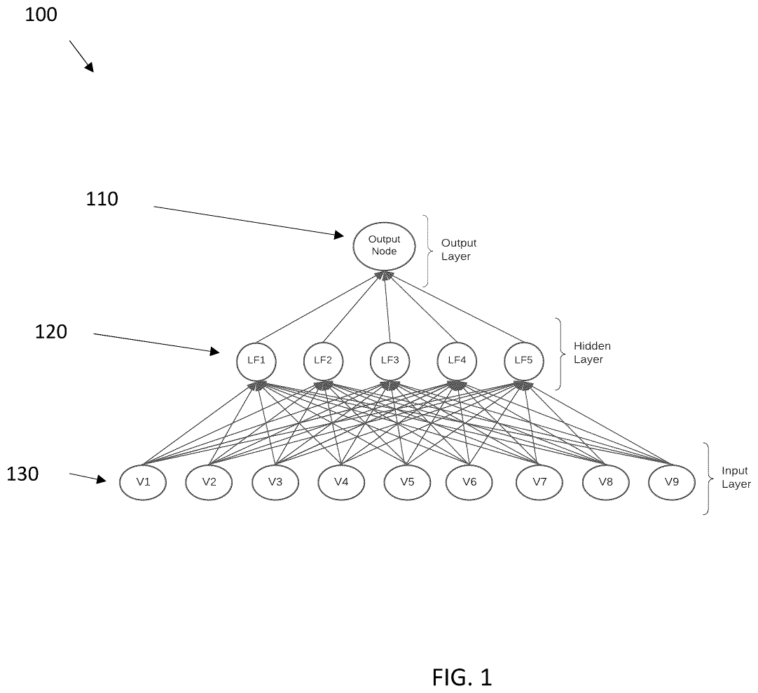

FIG. 1 is a diagram illustrating an example of a neural network model 100 with a hidden layer 120, in accordance with one or more embodiments of the current subject matter. As shown in FIG. 1, the neural network model 100 includes an input layer 130, one hidden layer 120, and one output layer 110. In some embodiments, the neural network model 100 may include multiple hidden layers 120. The input layers 130 may include input features, for example, features (V1, . . . , V9) as shown in FIG. 1. The input layers 130 may pass the input features to the following hidden layer(s) 120. Latent features (LF1, . . . , LF5) represent typically multitudes of complex relationships learned by the network during training (for example, non-linear transformations, and/or interactions of input features). The hidden layer(s) 120 is the predictive component of a neural network as it enables modeling of non-linear behaviors. The output layer 110 combines all the latent features connecting to it, thereby producing an output score to be used for decisioning. As shown in FIG. 1, the complexity of a neural network makes even a simple network with a single hidden layer and dense connections (i.e., fully connected) very hard to understand and explain. In this example in FIG. 1, each latent feature combines information from 9 input variables, which makes these densely connected latent features inherently unexplainable assuming there are 3 possible activation modes (Positive-activation, non-activation, and Negative-activation) for each input feature into the latent feature. Each single latent feature of the five in FIG. 1 therefore supports 19,683 possible activation states (i.e., 3⁹) and within each state there can be even more possible explanation activation modes. The combinatorial explosion of possible reasons for a latent feature activation in dense networks makes explaining the neural network 100 intractable to codify and even if one was able to assign reasons (some indeed multiple reasons for each activation state) to each of the 19,683 activation states for each latent feature—such an explosion of explanations would be in-tractable to any human and regulation, thus impairing the path to deployments of fully connected neural networks in highly regulated industries and environments.

As described in connection with FIG. 1, while the mathematical calculations and equations used within neural networks are often straightforward, creating human palatable explanation can be a very challenging task. Therefore, neural networks are often called “black box” models because their traditional architectures remain unexplainable and consequently incompatible with heavily regulated industries. Therefore, there is a need for platforms, systems, and methods that generate interpretable neural networks and provide demonstrated deterministic explanations for their outputs.

FIG. 1 represents a simple neural network with an input layer 130 composed of 9 input variables (V1, . . . , V9), known as input features, a single hidden layer 120 composed of 5 latent features (LF1, . . . , LF5), and an output layer 110 combining all the latent features into an output node. The “arrows” connecting into each of the five latent features and the output node represent the free parameters (weights) that a neural network learns during training. There are 50 weights to be learned and optimized: 45 weights between the input layer and the hidden layer (9 input features times 5 latent features) and 5 weights between the hidden layer and the output layer (5 latent features times 1 output node). The hidden layer is the key predictive component of a neural network as it enables modeling of non-linear behaviors. The latent features represent those complex non-linear behaviors learned from the input feature relationships during training.

Mathematically, these relationships are typically captured by applying non-linear transformations (activation functions) on interactions of numerous input features. This makes even a simple neural network with a single hidden layer and dense connections very hard to interpret and explain. In FIG. 1, each latent feature combines information from 9 input features, making densely connected latent features inherently uninterpretable and unexplainable. Each latent feature of the 5 in FIG. 1 supports 19,683 possible activation states (3⁹ assuming a bounded activation function with 3 activation modes and a total of 9 input features). The combinatorial explosion of possible reasons for a latent feature value in dense networks impairs the path to deployments of fully connected neural networks in highly regulated industries and environments.

As neural networks have become mainstream, they have attracted interest from regulators and governing bodies to take a closer look at how these models are used to make different business decisions. Automated decisions made with the help of neural networks affect the lives of many people daily, and out of respect for human values, neural networks must be trained, developed, and deployed in a way that emphasizes fairness, interpretability, and explainability. As more AI and machine learning regulations have appeared across the globe, it has become imperative that machine learning models such as neural networks are trained to enforce additional constraints related to interpretability and explainability. Although both terms are often used interchangeably, it is important to understand their differences, which also provides the rationale for the approach described herein. On the one hand, an interpretable neural network is characterized by a high level of architectural transparency related to a rigorous process of selecting the optimal and at the same time the minimum number of hidden layers, number of latent features in each of the hidden layers, and number of inputs (maximum of 2, in the preferred embodiment) sparsely connecting into each of the latent features. Such architectural transparency allows one to understand a neural network more intuitively by being able to closely observe its inner mechanics encapsulating its decision flow at the time of decision making. On the other hand, an explainable neural network is one whose inner mechanics encapsulating its decision flow at the time of decision making related, inter alia, to the most influential latent features and their activation states can be deterministically explained by a set of human-traceable and readable reasons (also referred to as explanations). In regulatory situations, automated decisions are often constrained to no more than 3-4 reasons to provide to consumers to enable less complexity in explanation. To meet this challenge, this invention develops a new training approach that enforces novel explainability constraints while developing interpretable neural networks through a process of iteratively constraining multiple latent feature activation modes of interpretable neural networks.

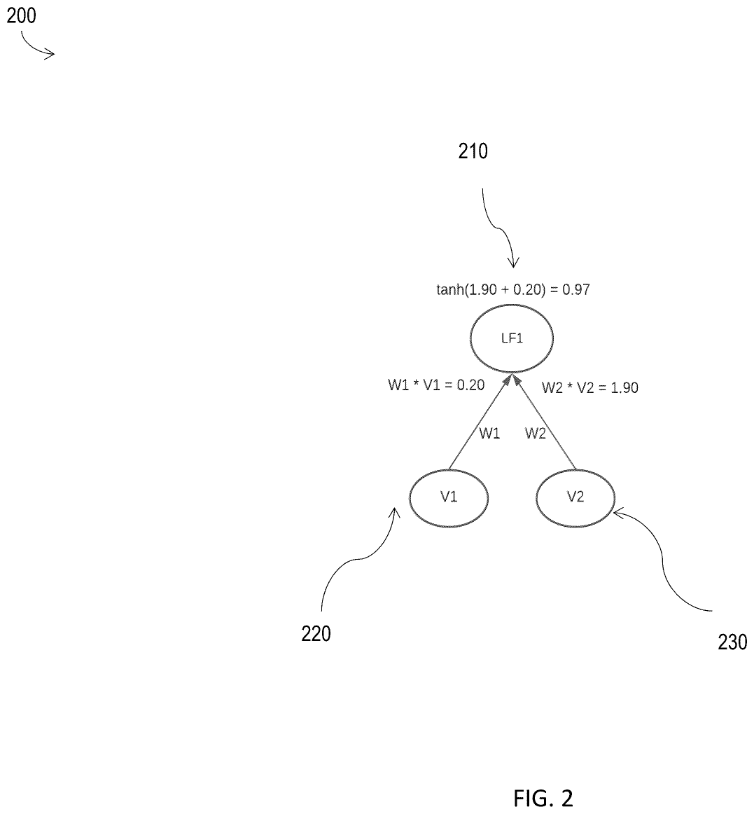

FIG. 2 is a diagram illustrating an example of a single latent feature LF1 with two incoming connections, in accordance with one or more embodiments of the current subject matter. As shown in FIG. 2, the limited number of inputs (i.e., input connections or incoming connections) allowed into a single hidden latent feature 210 is limited to no more than two connections.

The approach described herein may be based on the concept of hidden layer activation tuples (tuples). In some embodiments, the activation tuples may be associated with each of the data entries in a training dataset, and may indicate the set of activation values for a group of latent features in response to a data entry. These tuples may involve a finite number of latent features. For example, they may include a minimum of 1 and a maximum of N, where N is the total number of latent features and where the activation values of each latent feature exceed a pre-defined activation threshold. This threshold may be based on a sigmoidal-type activation function with 3 possible latent feature activation. Such tuples may represent the latent features that have the most prominent influence on an interpretable neural network's decision, such as the score calculated at the output layer. These latent features may be trained to become specialized feature detectors without overly co-adapting with other specific feature detectors, ensuring clearer and more interpretable outcomes. Each of the latent features may correspond to (e.g., may be or may include) a node (i.e., neuron) of the neural network.

In some embodiments, FIG. 2 may represent a single latent feature (LF1) 210 with two incoming connections 220 and 230. The pre-activation terms W1*V1=0.20 and W2*V2=1.90 may be the input feature values (V1 220 and V2 230, for a particular data entry) multiplied by the neural network's weights (W1 and W2) associating V1 and V2 to LF1. The activation value of LF1 may be calculated by applying a hyperbolic tangent tanh transformation to the sum of the pre-activation terms associated with the two incoming connections 220 and 230. In this case, the activation value of LF1 may be 0.97.

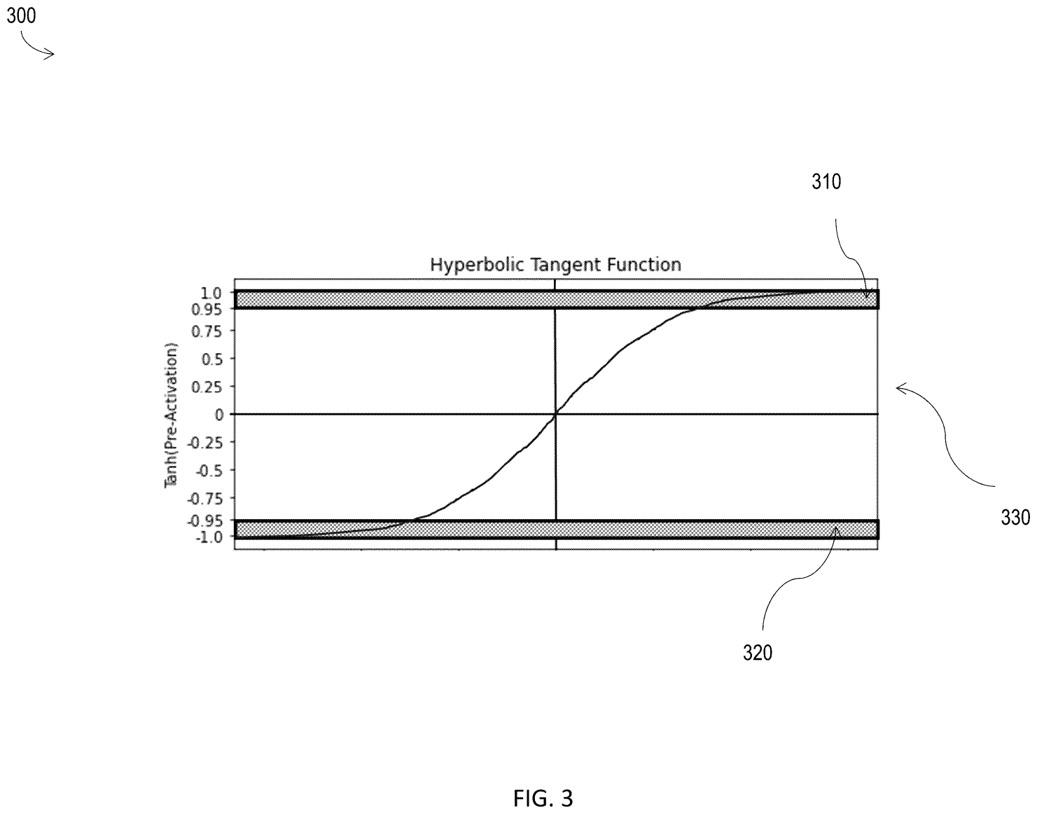

FIG. 3 is a diagram illustrating an example of an activation function, in accordance with one or more embodiments of the current subject matter. As shown in FIG. 3, the activation function may include hyperbolic tangent (tanh) function, the latent features' activation values may be categorized based on the following 3 activation modes:
Negative activation (−1) mode may be assigned for a latent feature's activation value less than or equal to −0.95, as shown by element 320.
Non-activation (0) mode may be assigned for a latent feature's activation value greater than −0.95 and less than 0.95, as shown by element 330.
Positive activation (1) mode may be assigned for a latent feature's activation value greater than or equal to 0.95, as shown by element 310.

FIG. 3 illustrates the 3 activation modes as regions of a tanh function. The areas of elements 310 and 320 may represent asymptotic regions corresponding to negative (−1) and positive (1) activation modes for a single latent feature (e.g., LF1). The element 330 area between 0.95 and −0.95 may represent the non-activation (0) mode.

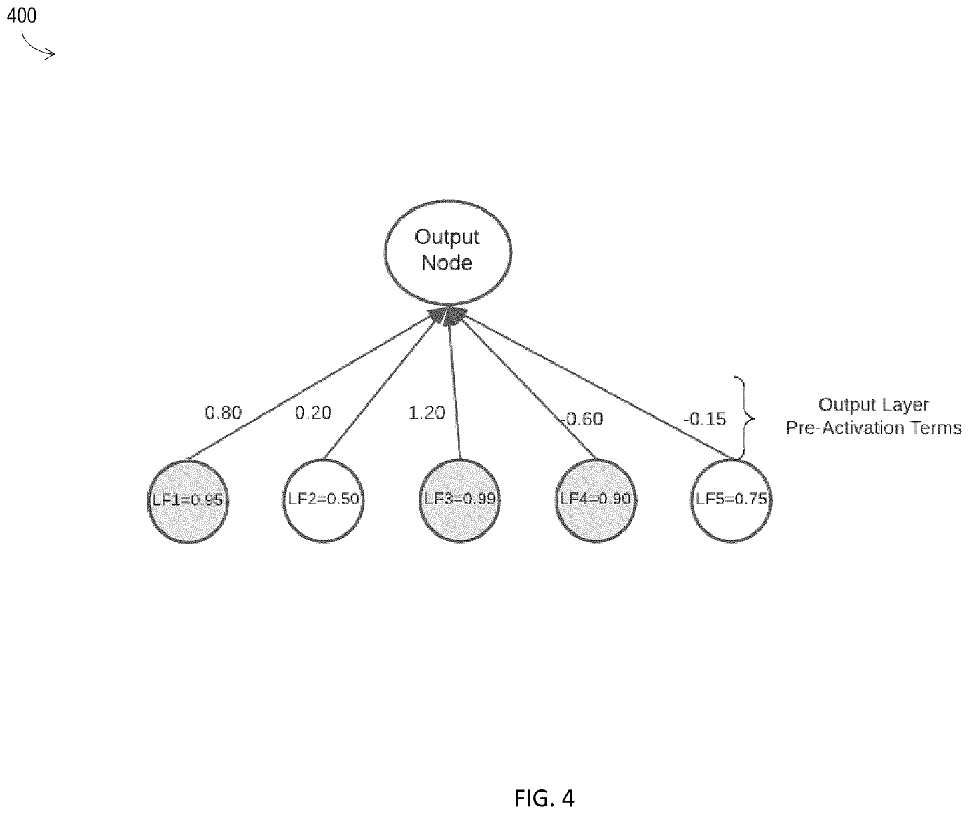

FIG. 4 is a diagram illustrating an example of latent features' (LF1, LF2, LF3, LF4, LF5) activation values and their corresponding pre-activation terms at the output layer, in accordance with one or more embodiments of the current subject matter. As shown in FIG. 4, there are 5 latent features (LF1, LF2, LF3, LF4, LF5) connecting into the output node. In some embodiments, to construct an activation tuple, the latent features may be first sorted by the magnitude of their output layer pre-activation terms' absolute values. The sorting process may result in the following order of latent features: (LF3, LF1, LF4, LF2, LF5). Based on this order, these latent features' activation values (0.99, 0.95, 0.90, 0.50, 0.75) may then be analyzed to determine their activation modes in accordance with the 3 tanh regions presented in FIG. 3. This logic may create a tuple of size 5 composed of the following elements: (1, 1, 0, 0, 0).

Per the approach described herein, explanations for only an M number of latent features may be produced (e.g., M=3, per typical automated decisioning explanation standards). The M parameter may be configurable depending on industry and domain-specific explainability requirements (e.g., M=4 for credit scoring). To constrain the explainability space to 3 possible explanations, further filtering of the latent features composing the (1, 1, 0, 0, 0) tuple may be performed. In this example, assuming M=3, the final tuple may contain the following sequence of activation modes (1, 1, 0) associated with LF3, LF1, and LF4. LF3, LF1, and LF4 may be the “top-3” latent features as evaluated by the magnitude of their output layer pre-activation terms' absolute values. The (1, 1, 0) tuple may be categorized as a tuple of size “2” because only 2 out of the 3 most influential latent features may have activation values that exceed the threshold for either the positive (1) or the negative (−1) activation mode. In some embodiments, each tuple's size may always be set at 3 elements (because M=3), but the tuple's category may be determined based on the total number of either positive (1) or negative (−1) activation modes across those 3 elements.

In some embodiments, assuming M=3, 5 major tuple size categories may be distinguished:
Tuple of size “0” where none of the “top-3” most influential latent features have activation values that exceed the threshold for either the positive (1) or the negative (−1) activation mode.
Tuple of size “1” where only one of the “top-3” most influential latent features has an activation value that exceeds the threshold for either the positive (1) or the negative (−1) activation mode.
Tuple of size “2” where two of the “top-3” most influential latent features have activation values that exceed the threshold for either the positive (1) or the negative (−1) activation mode (as shown in FIG. 4).
Tuple of size “3” where all the “top-3” most influential latent features have activation values that exceed the threshold for either the positive (1) or the negative (−1) activation mode.
Tuple of size “4+” where there are at least 4 (>=4) latent features that have activation values that exceed the threshold for either the positive (1) or the negative (−1) activation mode.

In practice, neural networks may have an arbitrary number of latent features. Even in highly regulated industries and environments, it is typical to see interpretable neural networks with 10+ latent features per hidden layer. Although those latent features may be architecturally interpretable, many of them may be “overfiring” (e.g., a high percentage of latent features with values exceeding the threshold for either the positive (1) or the negative (−1) activation mode) at the time of the final output layer's score calculation, making it not possible to provide definitive latent feature-level explanations based on the underlying latent features' activity, often dominated by tuples of size “4+” and in misalignment with embodiments that support automated decisioning explanation standards. This “overfiring” may often be a direct result of complex hidden layer co-adaptations developed during training. Consequently, the algorithm described in the approach herein may reduce latent features' activity associated with tuples of size “4+” while encouraging activity of tuples of size “1”, “2” and “3” to accentuate the learning process of the constrained number of latent features that capture the most important input feature interactions and their transformations in the latent space and to meet a standard of 3 explanations for automated decisioning—the approach described herein may be trivially extended to 4 explanations and constraining 5+ in applications where regulation prescribes up to 4 reasons such as in credit risk regulation. Such latent features constrained in the approach described herein may become specialized in detecting specific behaviors independently of other latent features in the hidden layer. The optimization of this objective may bring explainability complexity to the forefront of interpretable neural networks which may allow deterministically and with high confidence determination of the main drivers of an interpretable neural network's decision directly related to the activity of a maximum of an M number of latent features (within a given activation tuple) that lie along the key latent manifolds inside a highly-dimensional latent feature space. Interpretable neural networks that are trained using the approach described herein may be directed to learn simple, yet very structured latent manifolds within a larger latent manifolds' space.

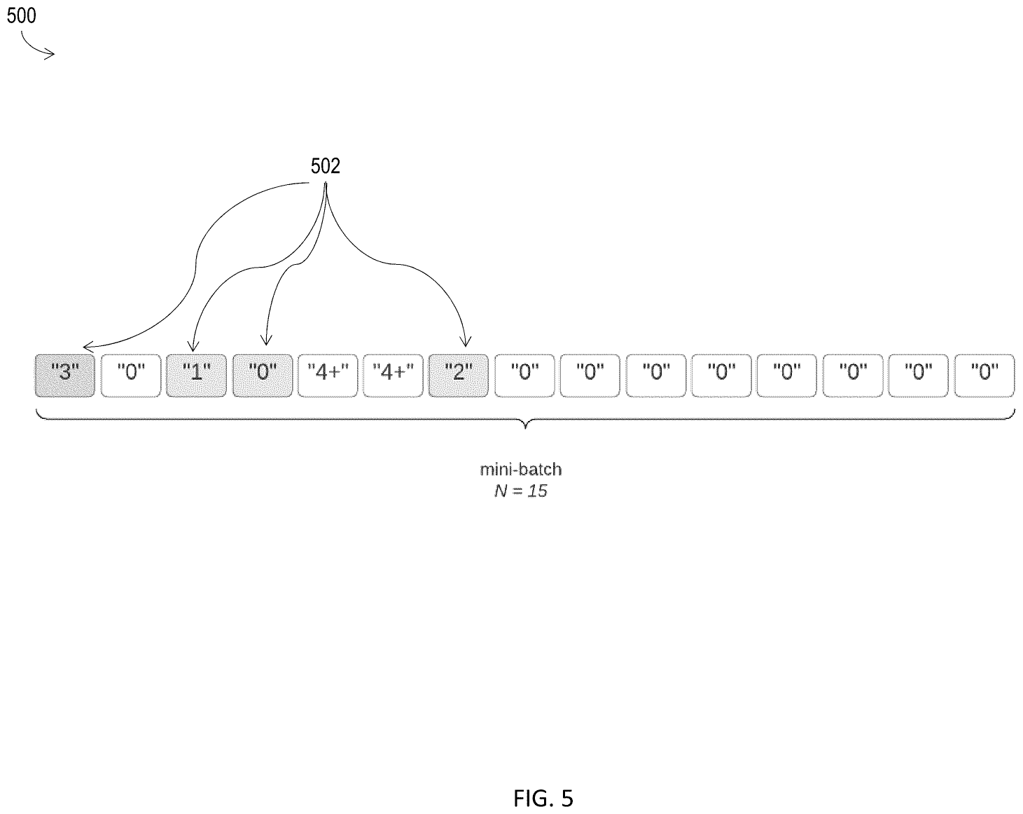

FIG. 5 is a diagram illustrating an example of a training mini-batch containing 15 data entries (e.g., transactions) and their activation tuples of different categories, in accordance with one or more embodiments of the current subject matter. As shown in FIG. 5, the approach described herein may constrain activation tuples to a set size M. It is important to emphasize that M can be set to an arbitrary number to constrain the tuple size depending on industry application and regulation area, with the most popular values of M being 3 or 4 reasons. For the purposes of the remainder of the description, M is set to 3.

The approach described herein may reduce latent features' activity associated with tuples of size “4+” while encouraging activity of tuples of size “1”, “2”, and “3”. In some embodiments, using a mini-batch momentum-based gradient descent optimization, the algorithm may analyze each neural network's training mini-batch composed of N training exemplars (data entries) so that the gradients' calculation and subsequent weights' updates are performed with respect to the loss function's value emphasizing constrained latent features' activity. To achieve the constrained latent features' activity, the contribution of training data entries representing tuples of size “4+” to the gradients' calculation may be reduced or minimized by a multiplicative factor signifying gradients' directions associated with tuples of size other than “1”, “2”, and “3” are reduced For example, the contribution of training data entries representing tuples of size “4+” may be minimized by applying a multiplicative factor to each “4+” transaction of factor, lamda where lamda varies from 0 to 1, where 0 is the transaction having zero contribution and 1 is having normal contribution to the gradient. Values of lamda between 0 and 1 reduce the effect of these transactions in the gradient calculation, for example could reduce their impact to that to a certain percentage using a loss function, such as 20%, 10%, 5%, 2%, etc. In some embodiments, the contribution of training data entries representing a tuple of a certain predetermined size may be suppressed to zero by setting lamda to zero, i.e., these data entries may be filtered out. Additionally or alternatively, to further emphasize the gradients' directions associated with tuples of size “1”, “2”, and “3”, the contribution of training data entries representing tuples of size “0” to the gradients' calculation may be reduced. For example, the contribution of training data entries representing tuples of size “0” may be minimized by applying a multiplicative factor, gamma to each “0” transaction in the training set. Where gamma varies from 0 to 1, where 0 is the transaction having zero contribution and 1 is having normal contribution to the gradient. Values of gamma between 0 and 1 reduce the effect of these transactions in the gradient calculation, for example could reduce their impact to that to a certain percentage using a loss function, such as 20%, 10%, 5%, 2%, etc. The frequency of tuples of size “0” may naturally decrease during a neural network's training while the latent features continue to learn and become specialized in detecting specific behaviors across the main training data's latent manifolds. The process of weighting the loss function's value may be initiated from the very first training epoch and may be executed until the training is completed.

FIG. 5 illustrates a training mini-batch example with 15 data entries (e.g., transactions) represented as activation tuples of different categories. The contribution of data entries representing tuples from predetermined categories (e.g., “4+” and “0”) to the loss function's value calculation and subsequent gradients' derivation may be minimized in the gradient calculation operation. As shown in FIG. 5, and based on the logic described above, only the “shaded” data entries 502 would be up-weighted for the gradients' calculation to emphasize the gradients' directions associated with tuples of size “1”, “2”, and “3”, assuming M is set to 3. As shown in FIG. 5, only a random 10% (1 data entry) of tuples of size “0” and 100% (3 data entries) of tuples of size “1”, “2”, and “3” would be up-weighted for the gradients' calculation and the remaining 90% (9 data entries) of tuples of size “0” as well as 100% (2 data entries) of tuples of size “4+” would be down-weighted for the gradients' calculation.

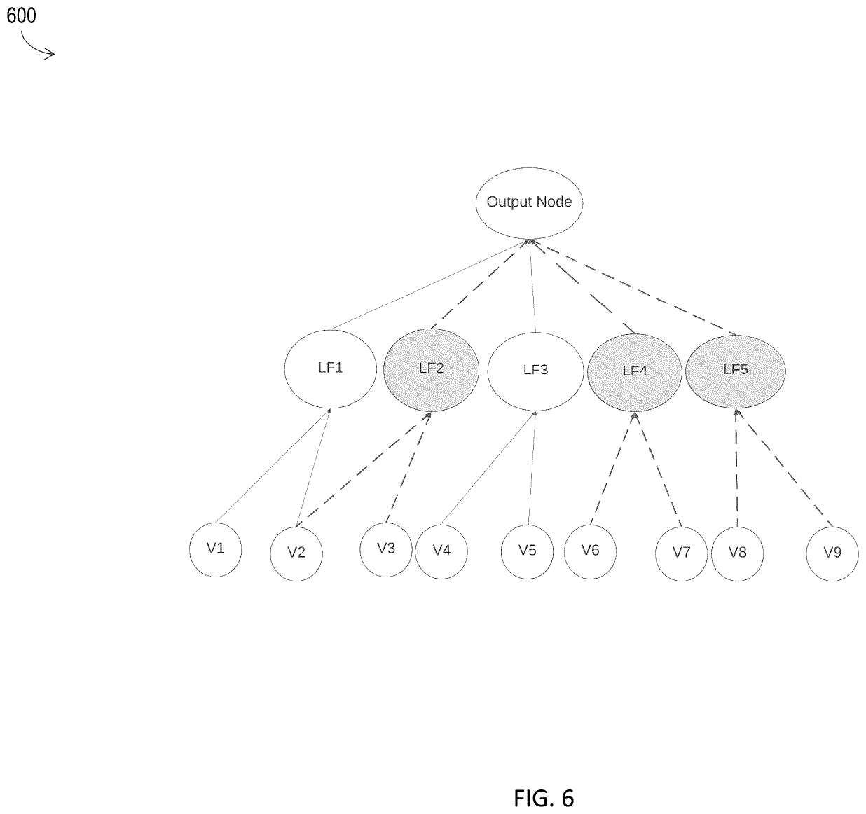

FIG. 6 is a diagram illustrating example of an interpretable neural network with a single hidden layer and 5 latent features with 2-input connections per latent feature. As shown in FIG. 6, the approach described herein involves a process of selective weights' updates where only the weights of the “top-3” most influential latent features, as evaluated by the magnitude of their output layer pre-activation terms' absolute values, are updated. The gradients associated with the remaining latent features may be zeroed out, subsequently penalizing the weights' updates of the latent features outside of the “top-3” for that data entry (e.g., a training mini-batch of size N).

In some embodiments, for a momentum-based mini-batch gradient descent optimization, statistics related to the moving average of gradients and their transformations are also zeroed out. In some embodiments, a neural network's parameters may be updated for each mini-batch. Consequently, at the end of each mini-batch's forward pass calculations, and before the gradients' derivation, the algorithm may capture the 3 latent features that most frequently (e.g., based on raw counts) appeared in the activation tuples across the mini-batch containing data entries (e.g., transactions) characterized by the latent features' activity primarily associated with tuples of size “1”, “2”, and “3”, and a random X % of tuples of size “0”.

The process of selective weights' updates concerns the hidden layer's weights (and biases) and the output layer's weights. This process may be triggered once the mean percentage of tuples of size “0” for the first time drops below a certain threshold (e.g., 25%, a configurable parameter). This threshold is evaluated across all mini-batches at the end of a given training epoch. For example, if the mean value of tuples of size “0” across all mini-batches at the end of epoch T is <=25% across all tuple categories, the process of selective updates may be triggered at epoch T+1 and continue until the training is completed. Once triggered, selective weights' updates may continue regardless of future fluctuations in the distribution of different tuple categories.

FIG. 6 represents an interpretable neural network where all latent features (LF1, LF2, LF3, LF4, LF5) have 2-input connections. In some embodiments, the “shaded” latent features (LF2, LF4, LF5—in this order) are assumed to be the “top-3” latent features that appeared most frequently (e.g., based on raw counts) across the activation tuples in the first mini-batch of the training epoch T+1 when the process of selective weights' updates is to be initiated. Thus, only the weights represented by the bold, dashed “arrows” and related to LF2, LF4, and LF5 may be updated before proceeding with the forward pass calculations for the next mini-batch. In some embodiments, the gradients associated with the current mini-batch, as well as their moving average statistics associated with LF1 and LF3, may be zeroed out, thereby penalizing the update process of the weights represented by the solid “arrows.”

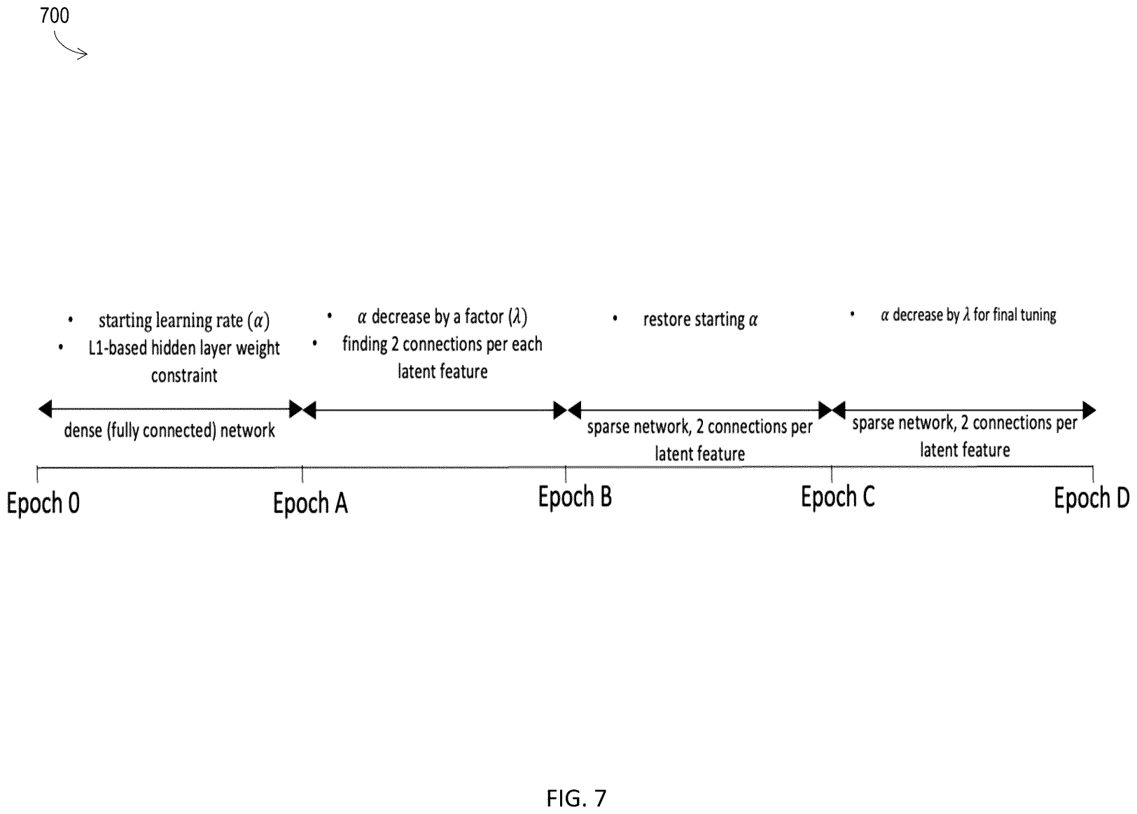

This section serves to further explain the above-described processes while incorporating them into interpretable and explainable neural network training frameworks. Both frameworks may assume a mini-batch momentum-based gradient descent optimization. The first training framework, A), focuses on training a strictly interpretable neural network with a single hidden layer and sparsely connected latent features with 2 incoming connections (input features). FIG. 7 is an example of a training framework A, in accordance with one or more embodiments. As shown in FIG. 7, 4 algorithmic stages are involved in the training framework A. The main objective of this framework is to construct and train an interpretable neural network with a single hidden layer and 2-input connections incoming into each of the latent features.

The stages, using an explicit learning rate scheduler, are in detail described below:

Epoch 0-Epoch A: In some embodiments, training starts at epoch 0 and continues until epoch A. During this stage, a fully connected neural network with a single hidden layer is trained without any modifications related to the gradients' operations and weights' updates. At the hidden layer-level, an L1-based weights' constraint may be applied to begin the first of the two processes of introducing sparsity. For example, the sum of each latent feature's absolute weights' values, between epoch 0 and A, may be constrained by a WC parameter (e.g., Σⱼ|wᵢⱼ|<=WC for all latent features i and their incoming weights). The starting learning rate (α), the value of epoch A, and the value of the WC parameter may be set using expert knowledge or domain expertise, or via different parameter tuning processes. In some embodiments, the value of the WC parameter is set approximately in the range of the number of allowed weights (e.g., 2) incoming into each latent feature. The recommended number of latent features may be within the [10, 15] interval.

Epoch A-Epoch B: With the start of epoch A, in some embodiments, the L1-based weights' constraint at the hidden layer may be deactivated, and the second process of introducing sparsity may be initiated to iteratively constrain the number of weights (cardinality) incoming into each latent feature. In the preferred embodiment, the cardinality may be set to 2, meaning each latent feature can only have 2 incoming non-zero weights. The weight importance for each weight incoming into each latent feature may be determined using the sorting criterion based on the product of a squared weight value and an exponential moving average of the corresponding squared gradient

$$( {w}_{ij}^{2} \times EMA {g}_{ij}^{2} ) .$$

Apart from the 2 most important weights, as determined by the above sorting criterion, the remaining weights may be iteratively squeezed to zero. Between epochs A and B, a may be decreased by a factor λ, for example, 0.1. Decreasing a while finding the 2-input connections for each latent feature allows the neural network to take smaller learning steps to reduce random fluctuations in the loss value calculation while transitioning from the “dense” to “sparse” architecture. Similarly to the previous stage, the value of epoch B and the value of λ may be set using expert knowledge or domain expertise, or via different parameter tuning processes. This stage aims to establish a fixed hidden layer's weight mask at the end of epoch B so that the following training stages focus on optimizing the weights for an interpretable neural network where all latent features, in a single hidden layer, have only 2-input connections. In view of the transition from a dense (i.e., fully connected) architecture to a sparse architecture, where the sparse architecture has at most a threshold number of inputs (i.e., incoming connections) to each latent feature (where the threshold may be set to 1 or 2), a sparse neural network (i.e., the neural network with the sparse architecture) may operate more efficiently than a corresponding dense neural network (i.e., a neural network with a dense architecture). Accordingly, the sparse neural network may provide improved model efficiency and interpretability and may be particularly suitable for edge computing, internet of things (IoT) devices, and applications with strict latency constraints

Epoch B-Epoch C: With the start of epoch C, the architecture of an interpretable neural network may be fully established. In some embodiments, the architecture relates to having identified the 2-input connections for each latent feature in the hidden layer. Between epochs B and C, a may be restored to its original value so that the neural network training is adjusted to the new interpretable architecture by taking larger learning steps. Similarly to the previous stages, the value of epoch C may be set using expert knowledge or domain expertise, or via different parameter tuning processes. In some embodiments, a may be further increased over its starting value.

Epoch C-Epoch D: This stage may involve the final tuning of the interpretable neural network with a recommended a decrease by a X value. In some embodiments, the value of X may be different between stages 4 and 2. As in all the previous stages, the value of epoch D may be set using expert knowledge or domain expertise.

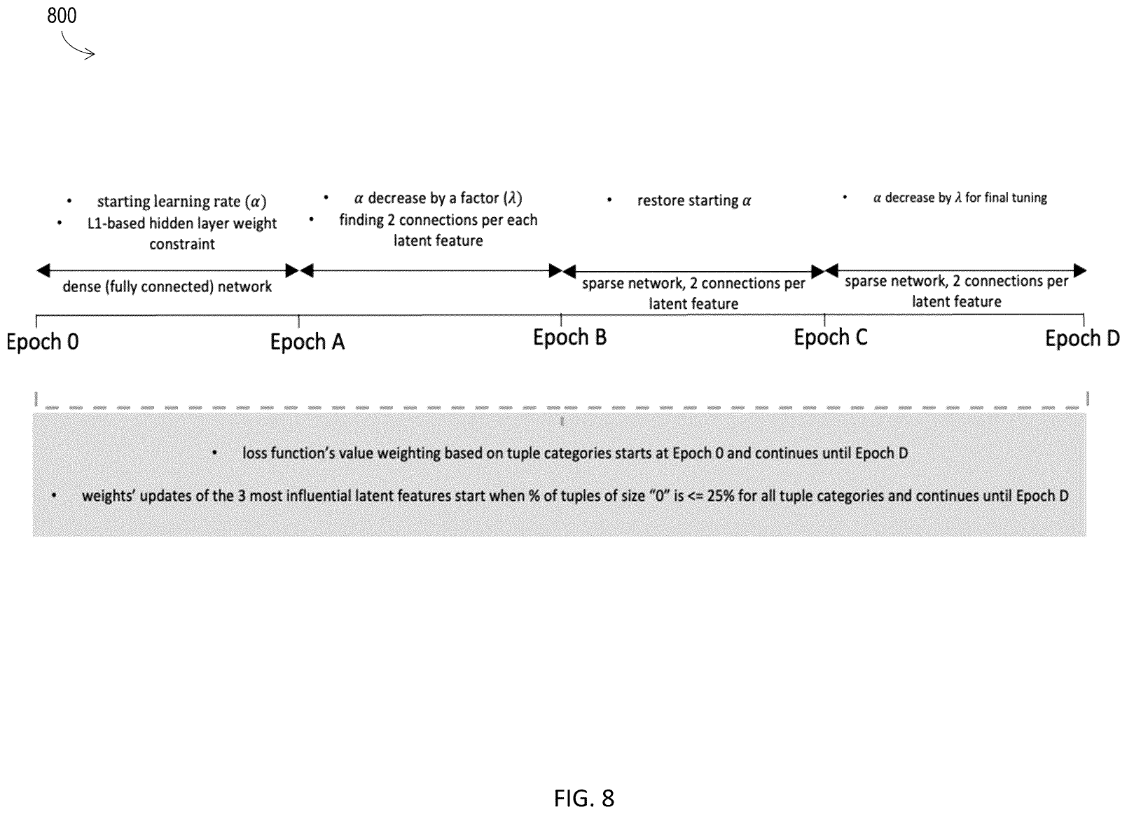

FIG. 8 is a graphical representation of the stages involved in the training framework B), with additional explainability constraints, in comparison with the framework A. As shown in FIG. 8, training framework B) involves the same major training stages as the framework A). The main difference between the two frameworks, however, is that the framework B) enforces additional explainability constraints related to loss functions' value weighting based on certain tuple categories and updating weights of the most influential latent features.

Starting from Epoch 0 and continuing until the training is completed at Epoch D, the contribution of data entries (e.g., transactions) categorized as tuples of size “4+” to the loss function's value may be minimized or removed from the gradient's derivation following each training mini-batch's forward pass calculations. Additionally, and to further emphasize the gradients' directions associated with tuples of size “1”, “2”, and “3”, only a random 10% of data entries categorized as tuples of size “0” may be utilized to affect the gradients.

The process of updating the weights of the most influential latent features may be initiated when the percentage of tuples of size “0” across all tuple categories is less than or equal to 25% (calculated as an arithmetic mean across all training mini-batches at the end of a given training epoch) and continues until the training is completed at Epoch D. For example, if the percentage of tuples of size “0” across all tuple categories is less than or equal to 25% at the end of epoch 100, the process of updating the weights of the most influential latent features (M=3) may start at epoch 101 and continue until Epoch D is completed.

The three most influential latent features may be selected based on the highest raw frequency counts across activation tuples within the training mini-batch containing data entries characterized by the latent features' activity primarily associated with tuples of size “1”, “2”, and “3”, and a random 10% of tuples of size “0”. Training framework B) may enable training interpretable and more explainable neural networks.

In some embodiments, training framework B) (FIG. 8) brings explainability to the forefront of an already interpretable neural network and consequently allows for determining with a higher level of confidence the main drivers of the output node's score computation directly influenced by the activity of a maximum of three latent features associated with the increased activity of tuples of size “1”, “2”, and “3”. Such latent features may represent simple, yet highly structured latent manifolds learned from the training data as they capture the most prominent input feature interactions and their transformations in a larger latent manifolds' space. The comparison of the two training frameworks is in detail described in the following section.

### Use Case

To demonstrate the unique aspects of training framework B) and the effects of its explainability constraints on an interpretable neural network, a comparative study was conducted to analyze latent features' activity associated with the five major tuple categories (“0”, “1”, “2”, “3” and “4+”) while training neural networks with both frameworks A) and B). The statistics related to latent features' activity were computed on a test set after the last training epoch. With both frameworks, neural networks were trained for 250 epochs (Epoch D=250 in FIG. 7 and FIG. 8). In addition to the statistics representing latent features' activity, neural networks' performance was measured as the area under the receiver operating characteristic (ROC) curve (AUC). The AUC was also measured on the test set after the last training epoch.

To train the neural networks, a real-world dataset representing credit card banking data entries (e.g., transactions) was used. In total, there were 1,963,841 data entries (1,472,549 in the training set and 491,292 in the test set) representing e-commerce/card-not-present data entries. The neural network architecture was fixed with a single hidden layer and 12 latent features. The input layer contained 22 engineered input features to detect fraudulent data entries. Regardless of the training framework, between epochs 0 and A (FIG. 7 and FIG. 8), a densely connected neural network was trained where all 22 input features connected to each of the 12 latent features. At the end of the training (after Epoch D=250 is completed), each of the 12 latent features would only have 2 incoming connections.

To determine the values for Epoch A, B, C, the starting learning rate (α), and the strength of the regularization constraint (WC) parameter to maximize the AUC value, a parameter search optimization was performed. Regardless of the neural network training framework, A) vs. B), mini-batch momentum-based gradient descent optimization (Adam) was used with a fixed mini-batch size of 4096. In both cases, X was equal to 0.1. For framework B), a random 10% of tuples of size “0” and 100% of tuples of size “1”, “2”, and “3” were up-weighted for the gradients' calculation, while tuples of size “4+” were down-weighted to zero for the gradients' calculation.

TABLE 1
Performance results and statistics representing arithmetic
mean values calculated across “top-20” training
runs (ranked by the AUC) for both training frameworks A) and B).

| | | | | % of | |
|---|---|---|---|---|---|
| | | First Epoch | % of | size “1”, | % of |
| | AUC | of Selective | size “0” | “2”, “3” | size “4+” |
| Framework | (%) | Weights' Updates | tuples | tuples | tuples |
| B) | 91.92 | 172 | 13.81 | 79.11 | 7.08 |
| A) | 92.17 | N/A | 0.05 | 36.58 | 63.37 |
| Absolute | −0.25 | N/A | 13.76 | 42.53 | −56.29 |
| Change (%) | | | | | |
| A vs. B | | | | | |

Table 1 summarizes the results of the comparative study. All the values represent mean values calculated across the “top-20” training runs (also referred to as trials), ranked by the AUC value, for both training frameworks A) and B). In total, the parameter search optimization included 160 training trials for each framework to find the values for Epoch A, B, C, the starting α, and the strength of the WC parameter that maximize the AUC value.

The key results are highlighted below:

Training framework B), through the described processes loss functions' value weighting of tuples and weights' updates of the most influential latent features, compared with training framework A) across 20 training trials, increased the activity of latent features associated with tuples of size “1”, “2”, “3” on average by 42.53% (79.11% of data entries vs. 36.58% for framework A). At the same time, the activity of latent features associated with tuples of size “4+” was reduced by an absolute 56.29% (63.37% for framework A to 7.08% for framework B).

Framework B) was able to increase the percentage of tuples of size “1”, “2”, “3” to 79.11% and decrease the percentage of tuples of size “4+” to 7.08%. Training framework B) brought explainability to the forefront of an already interpretable neural network by preventing complex hidden layer co-adaptations. Constraining latent features' activity during training to a limited number of active and prominent latent features at the time of decision making allows determining with a higher level of confidence which latent feature or a combination of latent features led an interpretable neural network to a specific decision, aligning the algorithm more closely with the reason/explanation space associated with explanation regulation.

The performance difference, as measured by the generic AUC value, was negligible.

Training framework B) maintained on average a higher percentage of tuples of size “0” compared with framework A)—13.81% vs. 0.05%. Data entries categorized as tuples of size “0” primarily represented the majority class (e.g., non-fraudulent data entries) with a high percentage of scores <=−0.95 within a [−1, 1] interval. Such scores often may not require explanations as they typically represent normal and well-known behaviors. With no latent features' activity being observed at the hidden layer level for certain data entries, the “top-3” most influential latent features (associated with the M parameter) will be selected strictly based on the magnitude of their output layer pre-activation terms' absolute values. From an explainability perspective, the presence of tuples of size “0” is less of an issue than the presence of tuples of size “4+”. The presence of tuples of size “4+” makes providing subsequent latent feature-level reasons more challenging due to the underlying and increased latent features' activity often associated with complex co-adaptations at the hidden layer level.

The approach described herein develops a method to enforce explainability constraints while training interpretable neural networks by converting their traditional densely connected counterparts. It brings explainability of interpretable neural networks by accentuating the learning process of a limited number of latent features (maximum of M, where M is prescribed by regulatory requirements) that capture the most significant input feature interactions and their transformations in the latent space. These latent features represent the key, highly structured, latent manifolds learned during training, becoming more prominent at the time of decision-making. This prominence allows for a higher level of confidence in determining which latent feature or combination of latent features led the neural network to a specific decision. The approach also prevents complex hidden layer co-adaptations from developing during training, ensuring that only a limited number of latent features need to cooperate to provide a response to incoming inputs at inference time. Consequently, it aligns interpretable neural network architectures with the prescribed and preferred number of explanations associated with automated decision-making, based on the industry specification of the number of reasons M.

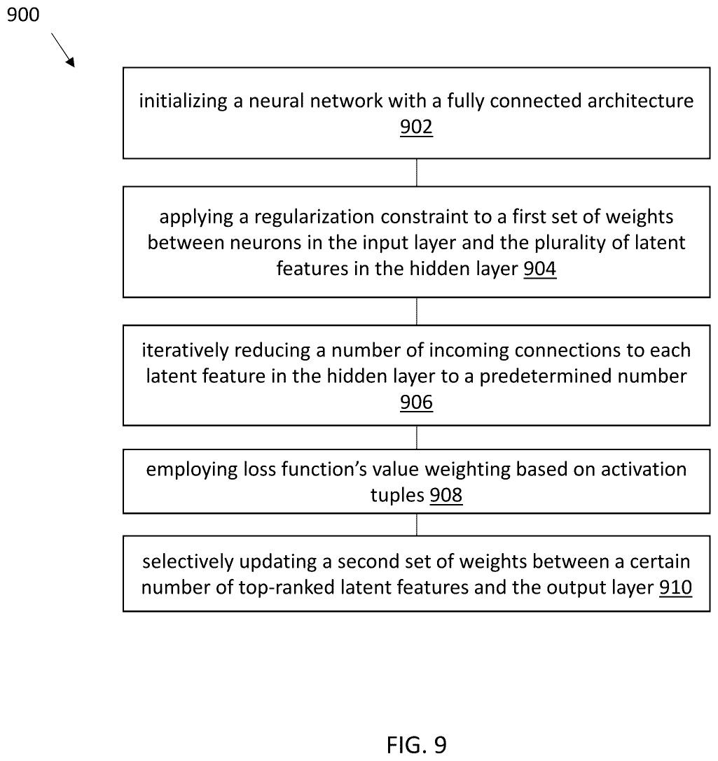

FIG. 9 is a diagram illustrating a flow chart of a process 900 for generating a classifier, in accordance with one or more embodiments of the current subject matter. As shown in FIG. 9, the process 900 may begin with operation 902, wherein the system may initialize a neural network with a fully connected architecture comprising an input layer, a hidden layer, and an output layer, wherein the hidden layer comprises a plurality of latent features. Next, in operation 904, the system may apply a regularization constraint to a first set of weights between neurons in the input layer and the plurality of latent features in the hidden layer. In some embodiments, this regularization constraint may be an L1-based, and per neuron, regularization constraint. In operation 906, the system may iteratively reduce a number of incoming connections to each latent feature in the hidden layer to a predetermined number based on the regularized first set of weights. For example, the predetermined number of incoming connections to each latent feature may be two. This process may involve evaluating an importance of each connection based on a magnitude of the regularized first set of weights and retaining only top-ranked connections for each latent feature, setting remaining connections to zero. The process 900 may then advance to operation 908, wherein the system signifies gradients' directions based on activation tuples of certain tuple categories. Contribution of data entries with activation tuples of size greater than a predetermined threshold to the loss function's value calculation may be limited or excluded. Contribution of data entries with activation tuples of size “0” to the loss function's value calculation may be limited, to a predefined percentage.

In operation 910, upon a determination that a proportion of data entries with activation tuples of size zero is below a specified threshold, the system may selectively update a second set of weights between a certain number of top-ranked latent features and the output layer based on activation values in a training process. The specified threshold for the proportion of data entries with activation tuples of size zero may be less than or equal to a predetermined percentage. The process 900 may further comprise adjusting a learning rate during different stages of the training process.

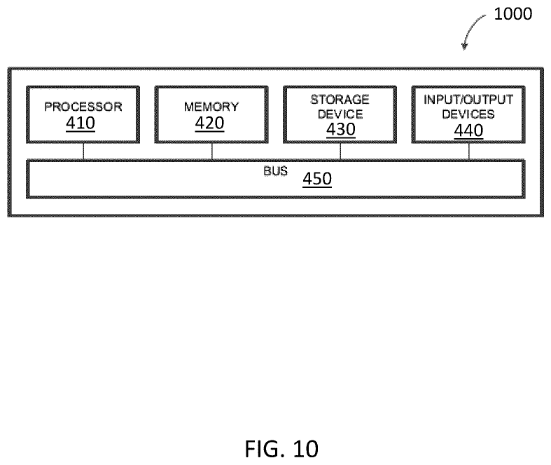

FIG. 10 depicts a block diagram illustrating a computing system 1000 consistent with implementations of the current subject matter. As shown in FIG. 10, the computing system 1000 can include a processor 410, a memory 420, a storage device 430, and input/output devices 440. The processor 410, the memory 420, the storage device 430, and the input/output devices 440 can be interconnected via a system bus 450. The computing system 1000 may additionally or alternatively include a graphic processing unit (GPU), such as for image processing, and/or an associated memory for the GPU. The GPU and/or the associated memory for the GPU may be interconnected via the system bus 450 with the processor 410, the memory 420, the storage device 430, and the input/output devices 440. The memory associated with the GPU may store one or more images described herein, and the GPU may process one or more of the images described herein. The GPU may be coupled to and/or form a part of the processor 410. The processor 410 is capable of processing instructions for execution within the computing system 1000. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 1000. The memory 420 can store data structures representing configuration object databases, for example. The storage device 430 is capable of providing persistent storage for the computing system 1000. The storage device 430 can be a floppy disk device, a hard disk device, an optical disk device, or a tape device, or other suitable persistent storage means. The input/output device 440 provides input/output operations for the computing system 1000. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 1000 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer-implemented method for generating a classifier, comprising:
initializing a neural network classifier with a fully connected architecture comprising an input layer, a hidden layer, and an output layer, wherein the hidden layer comprises a plurality of latent features;
applying a regularization constraint to a first set of weights between neurons in the input layer and the plurality of latent features in the hidden layer;
iteratively reducing a number of incoming connections to each latent feature in the hidden layer to a predetermined number per latent feature based on the regularized first set of weights;
upon a determination that a proportion of data entries with activation tuples of size “0” is below a specified threshold, employing a loss function weighting based on activation tuples, wherein contributions of data entries with activation tuples of size greater than a predetermined threshold are minimized and wherein contributions of data entries with activation tuples of size “0” are reduced to a predefined percentage; and
selectively updating a second set of weights of top-ranked latent features as evaluated by a magnitude of their contributions at the output layer in a training process.

2. The method of claim 1, wherein the predetermined number of incoming connections to each latent feature is one or two.

3. The method of claim 1, wherein the regularization constraint applied to the first set of weights is an L1-based regularization constraint.

4. The method of claim 1, wherein the specified threshold for the proportion of data entries with activation tuples of size “0” is less than or equal to a predetermined percentage.

5. The method of claim 1, further comprising adjusting a learning rate during different stages of the training process.

6. The method of claim 1, wherein the iteratively reducing the number of incoming connections to each latent feature in the hidden layer comprises evaluating an importance of each connection based on a magnitude of the regularized first set of weights.

7. The method of claim 6, wherein the iteratively reducing the number of incoming connections further comprises retaining only top-ranked connections for each latent feature, constraining the remaining connections to zero.

8. A computer program product comprising a non-transient machine-readable medium storing instructions that, when executed by at least one programmable processor, cause the at least one programmable processor to perform operations comprising:
initializing a neural network classifier with a fully connected architecture comprising an input layer, a hidden layer, and an output layer, wherein the hidden layer comprises a plurality of latent features;
applying a regularization constraint to a first set of weights between neurons in the input layer and the plurality of latent features in the hidden layer;
iteratively reducing a number of incoming connections to each latent feature in the hidden layer to a predetermined number per latent feature based on the regularized first set of weights;
upon a determination that a proportion of data entries with activation tuples of size “0” is below a specified threshold, employing a loss function weighting based on activation tuples, wherein contributions of data entries with activation tuples of size greater than a predetermined threshold are minimized and wherein contributions of data entries with activation tuples of size “0” are reduced to a predefined percentage; and
selectively updating a second set of weights of top-ranked latent features as evaluated by a magnitude of their contributions at the output layer in a training process.

9. The computer program product of claim 8, wherein the predetermined number of incoming connections to each latent feature is one or two.

10. The computer program product of claim 8, wherein the regularization constraint applied to the first set of weights is an L1-based regularization constraint.

11. The computer program product of claim 8, wherein the specified threshold for the proportion of data entries with activation tuples of size “0” is less than or equal to a predetermined percentage.

12. The computer program product of claim 8, further comprising adjusting a learning rate during different stages of the training process.

13. The computer program product of claim 8, wherein the iteratively reducing the number of incoming connections to each latent feature in the hidden layer comprises evaluating an importance of each connection based on a magnitude of the regularized first set of weights.

14. The computer program product of claim 13, wherein the iteratively reducing the number of incoming connections further comprises retaining only top-ranked connections for each latent feature, constraining the remaining connections to zero.

15. A system comprising:
at least one programmable processor; and
a non-transient machine-readable medium storing instructions that, when executed by the processor, cause the at least one programmable processor to perform operations comprising:
initializing a neural network classifier with a fully connected architecture comprising an input layer, a hidden layer, and an output layer, wherein the hidden layer comprises a plurality of latent features;
applying a regularization constraint to a first set of weights between neurons in the input layer and the plurality of latent features in the hidden layer;
iteratively reducing a number of incoming connections to each latent feature in the hidden layer to a predetermined number per latent feature based on the regularized first set of weights;
upon a determination that a proportion of data entries with activation tuples of size “0” is below a specified threshold, employing a loss function weighting based on activation tuples, wherein contributions of data entries with activation tuples of size greater than a predetermined threshold are minimized and wherein contributions of data entries with activation tuples of size “0” are reduced to a predefined percentage; and
selectively updating a second set of weights of top-ranked latent features as evaluated by a magnitude of their contributions at the output layer in a training process.

16. The system of claim 15, wherein the predetermined number of incoming connections to each latent feature is one or two.

17. The system of claim 15, wherein the regularization constraint applied to the first set of weights is an Li-based regularization constraint.

18. The system of claim 15, wherein the specified threshold for the proportion of data entries with activation tuples of size “0” is less than or equal to a predetermined percentage.

19. The system of claim 15, further comprising adjusting a learning rate during different stages of the training process.

20. The system of claim 15, wherein the iteratively reducing the number of incoming connections to each latent feature in the hidden layer comprises evaluating an importance of each connection based on a magnitude of the regularized first set of weights.
